(19) United States
(12) Patent Application Publication
(10) Pub. No.: US 2020/0239093 A1
(43) Pub. Date: Jul. 30, 2020

(54) Mobile Safety Device And Kickstand For Two-Wheelers

(71) Applicant: Thorsten Roth, Bochum (DE)

(72) Inventor: Thorsten Roth, Bochum (DE)

(21) Appl. No.: 16/634,937

(22) PCT Filed: Sep. 13, 2018
(86) PCT No.: PCT/EP2018/074742

§ 371 Date: Jan. 29, 2020

(30) Foreign Application Priority Data
Sep. 13, 2017 (EP) 17190863.5

(51) Int. Cl. B62H 1/02; B62H 5/00

(52) U.S. Cl. CPC B62H 1/02; B62H 1/06; B62H 5/005

(57) ABSTRACT

The invention relates to a two-wheeled bicycle stand having at least one foot (6) comprising at least one recess (9), said at least one recess forming at least one cavity upon contact between said foot (6) and a surface, characterized in that in at least one of said cavities a vacuum can be built up and released, and characterized in that the release of the vacuum and/or the build-up of the vacuum necessitates a verification. Such a bicycle stand can be fastened to a bicycle, resulting in improved stability and protection against theft.

The invention describes an improved kickstand for two-wheelers, which also serves as protection against theft.

### INTRODUCTION AND STATE OF THE ART

Kickstands for two-wheelers are part of two-wheelers or, respectively, can be attached to them if required and are intended to prevent the two-wheeler from falling over, in particular in the parking position. The current state of the art regards kickstands for two wheelers mostly detached from theft protection.

The utility models DE 29513869 U and DE 202006009295 U describe a length-adjustable kickstand which makes it possible to securely park a two-wheeler on non-horizontal surfaces. Obviously, alternatives to such a time-consuming adjustment of the length of the kickstand for secure parking are, however, of interest.

The publication FR 1 002 566 A describes a two-wheel stand which, when in contact with the ground and subsequently generating a vacuum at the intermediate surface, connects these with each other.

Various documents of the prior art disclose the theft protection afforded by kickstands for two-wheelers. For example, DE 3715882 A and WO 2015/008283 A describe a motorcycle kickstand, which also serves as theft prevention device. The motorcycle kickstand described therein can only be lifted up by using the ignition key. This means when the kickstand is folded out, the motorcycle cannot be simply wheeled away. Similarly, the prior art DE 3211367 A and EP 1 388 489 A describe a two-wheeler, in particular a bicycle, with a kickstand, whereby the kickstand can be locked in the parking position.

Although the two-wheeled kickstands fixed in this way prevent the two-wheeler from being driven away or wheeled unauthorized, it is still possible to move the two-wheeler by carrying, which is particularly for lightweight two-wheelers, such as bicycles, easily possible. Also, no improvements regarding the stability are achieved with these kickstands for two-wheelers.

It is an object of the invention to provide a kickstand for two-wheelers with improved standing properties, which, additionally, contributes to theft prevention. A′ kickstand for two-wheelers according to the current invention should be, preferably, effective and simple to use in daily life and producible at low cost. In addition, installation at existing two-wheelers should be easy to accomplish. The stability of two-wheelers using the kickstand according to the invention should be improved. In addition, the kickstand according to the invention should also function as a theft protection for the two-wheeler.

This is achieved by the kickstand for two-wheelers according to the present invention.

The kickstand for two wheelers of the present invention has at least one foot 6 having at least one recess 9, wherein by contacting this foot 6 with a surface, this at least one recess 9 forms at least one cavity, whereby in at least one of these cavities a vacuum can be built up and released. The two-wheel stand is then characterised by the fact that reducing the vacuum and/or build-up of the vacuum requires verification.

The at least one foot 6 of the kickstand for two-wheelers is preferably made of a flexible material, such as rubber and/or flexible silicone, which adheres to the surface when vacuum is applied. Such materials are known to the person skilled in the art.

The term “suction base” is also used for this foot because of its ability to adhere. The terms “foot” 6 and “suction base” 6 are used synonymously and describe the part of the kickstand for two-wheelers which contacts the surface.

The foot 6 is a part of the kickstand for two-wheelers but it can, preferably and in addition, be moved independently of it. This enables secure immobilization of the two-wheeler on uneven and/or inclined surfaces.

The surface according to the invention is in general the ground on which the kickstand for two-wheeler stands with at least one foot. However, it can be a different surface as for example a wall.

Preferably, the kickstand for two-wheelers according to the invention possesses a hollow duct 2, which connects the suction base 6 to a valve, and the vacuum can be removed or built up via this connection.

In one embodiment, the kickstand for two-wheelers according to the invention is attached to a two-wheeler.

Possible techniques for attaching the kickstand for two-wheelers to a two-wheeler are known to the person skilled in the art and comprise, for example, adhesive connections, welded connections and screw connections.

Two-wheelers in the meaning of the current invention comprise non-motorized two-wheelers, for example bicycles, and motorized two-wheelers, for example motorcycles, mopeds, motor scooters, but also motorized bicycles.

Bicycles within the scope of the invention comprise non-motorized bicycles and motorized bicycles. Motorized bicycles are those with an (additional) electric drive. Examples of this are e-bikes and pedelecs or S-pedelecs.

If a vacuum is present in at least one of the cavities of the kickstand for two-wheelers, the two-wheeler with the kickstand for two-wheelers according to the invention has superior stability in the parking position since the vacuum “adheres” the foot 6 and thus the kickstand for two-wheelers and the two-wheeler onto the surface.

According to the invention, the “parking position” or “parking” or “park mode” mean that the two-wheeler is standing at a place with the kickstand for two-wheeler extended and the foot 6 contacts a surface.

Preferably kickstands for two-wheelers according to the current invention, which are attached to a two-wheeler, can be extended/folded out or retracted/folded in, just like conventional kickstands for two-wheelers. In the extended state, a kickstand for two-wheelers supports the stability of the attached two-wheeler in the park mode by contacting a surface such as the ground. In retracted state, no surface (or at most a surface on the two-wheeler) is contacted so that the two-wheeler can be moved or driven. Accordingly, the kickstand for two-wheelers possesses, for example, a ball-and-socket joint 3 for extending or retracting the kickstand for two-wheelers, when attached to a two-wheeler.

In the context of the invention, kickstands for two-wheelers comprise kickstands for two-wheelers which are known to a person skilled in the art, such as, for example, side and rear kickstands. Both single leg, as well as double leg kickstands, are both kickstands according to the invention.

When using double leg kickstands or multiple kickstands or kickstands with several feet, a vacuum can be produced in only one of these feet, but also in several or all of them.

In addition to the increased standing properties, the “adhering” of the kickstand for two-wheelers to a surface prevents unauthorized movement of the two-wheeler, whereby the kickstand for two-wheelers also serves as an anti-theft protection of the two-wheeler.

If, for example, a kickstand for two-wheelers according to the invention, which is attached to a two-wheeler, has ground contact (the corresponding two-wheeler thus parks), the at least one cavity of the suction base can be evacuated so that a vacuum exists in this at least one cavity. A corresponding strength of the vacuum (or the level of the pressure difference) prevents both the unlawful (theft) and the unwanted (“falling over”) movement of the two-wheeler.

According to the invention, evacuation means the generation of a vacuum, that is, a pressure which is lower than the ambient pressure.

The kickstand for two-wheelers according to the invention can have a pressure reading, which indicates the magnitude of the vacuum in the suction base 6. Such a pressure reading can also or instead be located on the two-wheeler.

In one embodiment the removal/or the build-up of the vacuum in the kickstand for two-wheelers requires verification.

By verification it shall be prevented that the unauthorized removal of the vacuum is conducted, as such an unauthorized pressure equalisation would unintentionally remove the increased stability and the anti-theft protection of the kickstand for two-wheelers according to the invention or, respectively, of the attached two-wheeler.

According to the invention, pressure equalization means an adjustment of the pressure in the foot to the ambient pressure.

This verification is intended to ensure that only the authorized person(s) can initiate the pressure equalization and thus release the two-wheeler from the parking position. Such verification can be carried out, for example, analog or digital. Upon successful verification, for example, a valve may subsequently be opened or a valve opens and, as a result, ambient atmosphere flows into the at least one cavity of the foot and a pressure equalization takes place.

Examples of the analog verification comprise the use of a key or a numerical code. Examples of digital verification comprise the use of an “app” or a wireless remote control.

The use of an “app” means the digital verification by means of a program on a portable computer, such as a smartphone, which transmits a corresponding verification signal.

In particular, when an analog verification is used, a servomotor with a receiving device, for example an antenna, is preferably connected to a valve. In particular when two-wheelers with electrical components or a combustion engine are used, the energy required for this purpose can be obtained from these components. Alternatively and/or additionally and/or as a safeguard, for example, a battery can be used, which can be charged, for example, by pedaling the pedals during normal travel when a bicycle is used as a two-wheeler.

The analog verification is preferably carried out by means of a coded (radio) signal.

In a preferred embodiment, the verification takes place via an “app” by means of a mobile device signal, such as a smartphone.

In one embodiment, the kickstand for two-wheelers according to the invention has a device for the manual generation of the vacuum.

The manual generation of the vacuum can be carried out, for example, by means of a pressure-surface 7. In the parking mode, a force conducted on this pressure-surface 7 in the direction of the surface causes a contraction of the at least one cavity in the at least one foot 6 of the two-wheel stand. When this force is removed, the expansion of this at least one cavity takes place. If, for example, a correspondingly configured valve is connected to the foot, air can exhaust when contracting the cavity, but air cannot flow back when the cavity is expanding, resulting in a vacuum in the foot.

An integrated manual pump for generating a vacuum is also conceivable.

In one embodiment, the vacuum is generated automatically.

In addition, or as an alternative to the described manual vacuum generation, other methods for evacuation can also be used. For example, with an automated pump. In particular when two-wheelers with electrical components or a combustion engine are used, the automated pump can receive its energy from these components. As an alternative and/or additive and/or as a safeguard for such a pump, a battery can be used, for example. Such a battery can be charged, for example, by pedaling the pedals during normal travel when a bicycle is used as a two-wheeler.

The verification for the build-up of the vacuum can be carried out analogously to the verification described above for pressure equalization. Successful verification can, for example, close a valve, thereby preventing pressure equalization of any emerging or existing vacuum in the at least one cavity of the foot 6 with the environment.

This verification for the build-up of the vacuum is also preferably conducted via an “app”, which is implemented, for example, by means of a smartphone.

In one embodiment, the at least one foot 6 of the kickstand has at least two recesses.

Preferably, the foot is divided into at least one outer recess 10 and at least one inner recess 11, the at least one outer recess 10 preferably enclosing the at least one inner recess 11. Upon contact with a surface, at least one outer cavity and at least one inner cavity are then present, the at least one outer cavity preferably enclosing the at least one inner cavity.

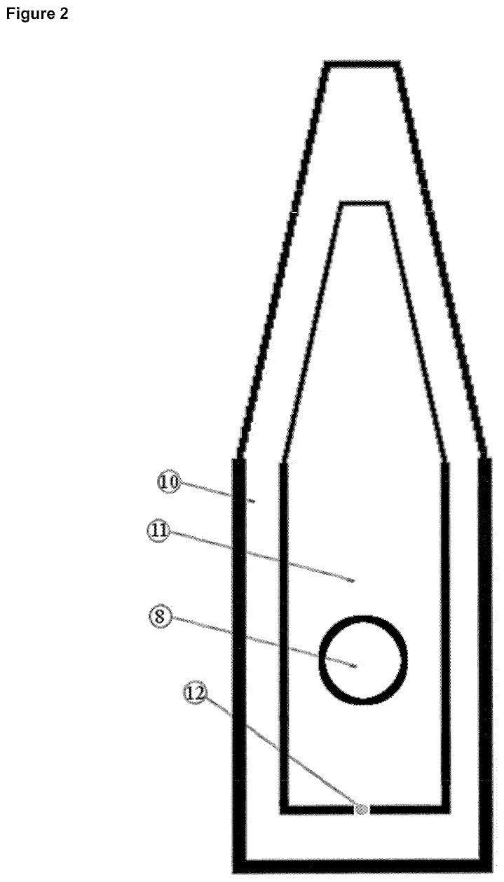

The at least one outer cavity is preferably separated from the at least one inner cavity, or is only connected via a valve 12 or something similar. This valve 12 is designed in such a way that pressure equalization between the at least one outer cavity and the environment does not cause pressure equalization between this outer cavity and the at least one inner cavity, while evacuating the at least one inner cavity also evacuates the at least one outer cavity. Alternatively, the evacuation and/or the pressure equalization of the different cavities can also take place separately. FIG. 2 depicts a corresponding embodiment.

As a result of such a setup if, for example, the material in the region of the outer cavity and the environment is damaged or pressure equalization of the at least one outer cavity occurs due to another reason (for example, in the case of an attempted theft by trying to crack the cavity open) the other, i.e. internal cavities still maintain a vacuum.

If, for example, an unauthorized person damages the at least one outer cavity in order to force pressure equalization or attempts to lift the suction base 6 in order to equalize the pressure, this only results in pressure equalization of the at least one outer cavity and the vacuum in the further, i.e. inner cavities or unaffected outer cavities remains, whereby an unauthorized movement of the two-wheeler is furthermore prevented.

In an embodiment, the bicycle stand comprises at least one hollow duct, a receiving device for receiving a verification signal, a valve and a device for opening or closing the valve, wherein the at least one hollow duct connects the at least one recess of the foot to the environment and comprises the valve. The hollow duct, the receiving device for receiving a verification signal and the device for opening or closing the valve are preferably located on the foot (6), since such a construction is advantageous both structurally and statically.

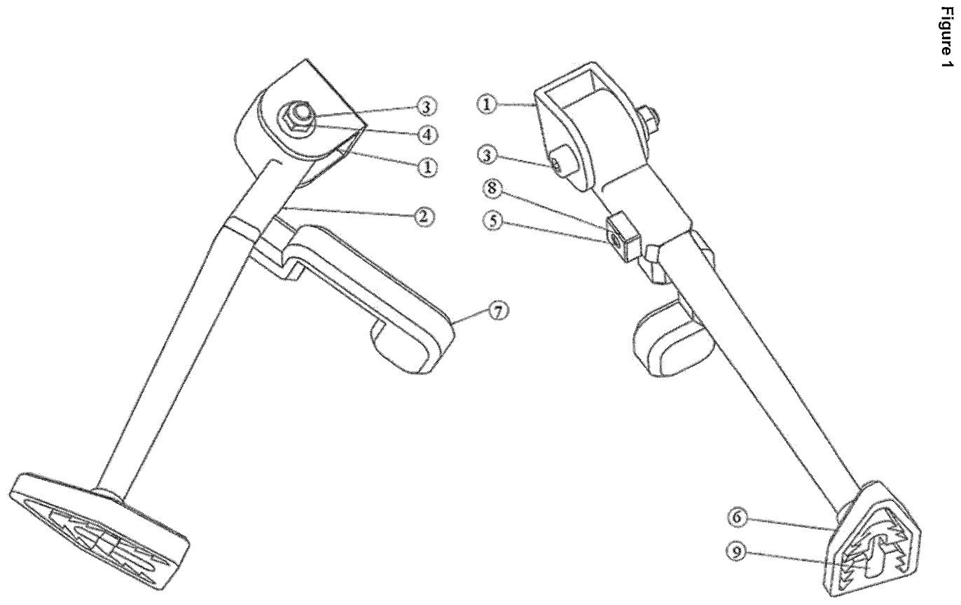

FIG. 1

FIG. 1 depicts schematic representations of a kickstand for two-wheelers according to the invention from two different perspectives. Depicted are a mounting surface 1 and a connecting screw 4 for attaching the kickstand for two-wheelers to a two-wheeler. The kickstand with hollow duct 2 connects the suction base 6 to the inlet opening of the hollow duct 8. At this inlet opening 8 there is situated a valve module with antenna 5, which can be controlled by a mobile phone app. The suction base 6 has recesses 9 which form cavities, for example, when the suction base 6 is connected to the ground. Furthermore, the figure depicts a ball-and-socket joint 3, which allows folding the kickstand (when attached to a two-wheeler) in and out. The figure also shows a pressure surface 7, which allows to manually produce a vacuum in the suction base 6.

FIG. 2

FIG. 2 depicts the schematic representation of a suction base 6 of a kickstand for two-wheelers according to the invention from “below”. “Below” thereby means (with reference to FIG. 1) along the line of sight from the suction base 6 to the mounting surface 1. FIG. 2 depicts an outer recess 10 and an inner recess 11, the outer recess 10 completely surrounding the inner recess 11. These two recesses 10 and 11 are connected to one another only by a valve 12. In the inner recess 11 there is also the inlet opening of the hollow duct 8, which allows the evacuation or pressure equalization of the inner and outer cavities.

### LIST OF REFERENCE NUMBERS

1: mounting surface
2: stand with hollow duct
3: ball-and-socket joint
4: connecting screw
5: valve module with antenna
6: suction base
7: pressure surface
8: inlet opening of the hollow duct
9: recess
10: outer recess
11: inner recess
12: valve

1-8. (canceled)

9. A kickstand for two-wheelers, the kickstand comprising at least one foot-having at least one recess, wherein by contacting the at least one foot with a surface, the at least one recess forms at least one cavity together with the surface, wherein a vacuum can be generated and/or released within the at least one cavity, and wherein the release of the vacuum and/or the generation of the vacuum requires verification.

10. The kickstand according to claim 9, wherein the kickstand is attached to one selected from the group consisting of a two-wheeler and a bicycle.

11. The kickstand according to claim 9, wherein the kickstand further comprises at least one selected from the group consisting of (i) a device for the manual generation of the vacuum, and (ii) a device for the automatic generation of the vacuum.

12. The kickstand according to claim 10, wherein the kickstand further comprises at least one selected from the group consisting of (i) a device for the manual generation of the vacuum, and (ii) a device for the automatic generation of the vacuum.

13. The kickstand for two-wheelers according to claim 9, wherein the at least one foot of the kickstand has at least two recesses.

14. The kickstand for two-wheelers according to claim 10, wherein the at least one foot of the kickstand has at least two recesses.

15. The kickstand for two-wheelers according to claim 11, wherein the at least one foot of the kickstand has at least two recesses.

16. The kickstand for two-wheelers according to claim 12, wherein the at least one foot of the kickstand has at least two recesses.

17. The kickstand according to claim 9, wherein the kickstand further comprises:
at least one hollow duct comprising a valve,
a device for opening or closing the valve, and
a receiving device for receiving a verification signal,
wherein the at least one hollow duct connects the at least one cavity of the foot with the environment.

18. The kickstand according to claim 10, wherein the kickstand further comprises:
at least one hollow duct comprising a valve,
a device for opening or closing the valve, and
a receiving device for receiving a verification signal,
wherein the at least one hollow duct connects the at least one cavity of the foot with the environment.

19. The kickstand according to claim 11, wherein the kickstand further comprises:
at least one hollow duct comprising a valve,
a device for opening or closing the valve, and
a receiving device for receiving a verification signal,
wherein the at least one hollow duct connects the at least one cavity of the foot with the environment.

20. The kickstand according to claim 12, wherein the kickstand further comprises:
at least one hollow duct comprising a valve,
a device for opening or closing the valve, and
a receiving device for receiving a verification signal,
wherein the at least one hollow duct connects the at least one cavity of the foot with the environment.

21. The kickstand according to claim 13, wherein the kickstand further comprises:
at least one hollow duct comprising a valve,
a device for opening or closing the valve, and
a receiving device for receiving a verification signal,
wherein the at least one hollow duct connects the at least one cavity of the foot with the environment.

22. The kickstand according to claim 14, wherein the kickstand further comprises:
at least one hollow duct comprising a valve,
a device for opening or closing the valve, and
a receiving device for receiving a verification signal,
wherein the at least one hollow duct connects the at least one cavity of the foot with the environment.

23. The kickstand according to claim 15, wherein the kickstand further comprises:
at least one hollow duct comprising a valve,
a device for opening or closing the valve, and
a receiving device for receiving a verification signal,
wherein the at least one hollow duct connects the at least one cavity of the foot with the environment.

24. The kickstand according to claim 16, wherein the kickstand further comprises:
at least one hollow duct comprising a valve,
a device for opening or closing the valve, and
a receiving device for receiving a verification signal,
wherein the at least one hollow duct connects the at least one cavity of the foot with the environment.

25. The kickstand according to claim 17, wherein the at least one hollow duct, the receiving device for receiving the verification signal and the device for opening or closing the valve are located on the foot.

26. The kickstand according to claim 18, wherein the at least one hollow duct, the receiving device for receiving the verification signal and the device for opening or closing the valve are located on the foot.

27. The kickstand according to claim 19, wherein the at least one hollow duct, the receiving device for receiving the verification signal and the device for opening or closing the valve are located on the foot.

28. The kickstand according to claim 20, wherein the at least one hollow duct, the receiving device for receiving the verification signal and the device for opening or closing the valve are located on the foot.
